(19) United States
(12) Patent Application Publication
(10) Pub. No.: US 2024/0328330 A1
(43) Pub. Date: Oct. 3, 2024

(54) BEARING AREA HEATING FIXTURE AND METHOD

(71) Applicant: Government of the United States, as represented by the Secretary of the Air Force, Wright-Patterson AFB, OH (US)

(72) Inventor: Colin Ramey, Misawa AB (JP)

(73) Assignee: Government of the United States, as represented by the Secretary of the Air Force, Wright-Patterson AFB, OH (US)

(21) Appl. No.: 18/441,012

(22) Filed: Feb. 14, 2024

Related U.S. Application Data
(60) Provisional application No. 63/492,779, filed on Mar. 28, 2023.

(51) Int. Cl. F01D 25/28; F28C 3/00

(52) U.S. Cl. CPC F01D 25/285; F28C 3/005; F05D 2230/72

(57) ABSTRACT

A fixture for use in heating an article, which article has two open ends and portions that define an interior space. The fixture includes a first component and a second component. The first component includes a first cover for covering one open end of an article. The second component includes a second cover for covering another open end of the article. At least one of the first and second components includes a mechanism for joining the first and second components together around the article in a spaced apart relationship. At least one of the components includes a port for transferring heat into the interior space of the article. A method of using the fixture for heating a portion of a turbine engine in order to service the same is also provided.

Pursuant to 37 C.F.R. § 1.78 (a) (4), this application claims the benefit of and priority to prior filed co-pending Provisional Application Ser. No. 63/492,779, filed Mar. 28, 2023, which is expressly incorporated herein by reference.

### RIGHTS OF THE GOVERNMENT

The invention described herein may be manufactured and used by or for the Government of the United States for all governmental purposes without the payment of any royalty.

### FIELD OF THE INVENTION

The present invention relates generally to heating articles, and more particularly to a fixture and a method for heating part of a turbine engine in order to service the same.

### BACKGROUND OF THE INVENTION

Turbine engines, including jet engines, are composed of components that are manufactured with very tight tolerances. Such components comprise parts that fit together with very precise tolerances. Some of these components must be heated to elevated temperatures in order to install and/or remove parts from the component.

The #5 bearing area in the F110 is a critical component that supports the shaft of the LP turbine. Tight tolerance is vital to ensure that the shaft remains centered and has no lateral movement, which would produce engine vibrations. To ensure this fit, heat must be applied to expand the housing enough to accept the bearing.

When servicing F110-100/129 model jet engines, in some cases, it is necessary to heat the #5 bearing area on the engine. The current method of heating the #5 bearing area on the engine involves using a heat gun to heat the bearing area. This process can take over 20 minutes and can cause uneven temperatures due to the heat not being contained in the intended area.

There is a need to provide faster and more even heating of the #5 bearing area on F110-100/129 model engines.

### SUMMARY OF THE INVENTION

The present invention relates generally to heating articles, and more particularly to a fixture and a method for heating part of a turbine engine in order to service the same.

While the invention will be described in connection with certain embodiments, it will be understood that the invention is not limited to these embodiments. To the contrary, this invention includes all alternatives, modifications, and equivalents as may be included within the spirit and scope of the present invention.

A fixture is provided for use in heating an article that has two open ends and portions that define an interior space. In one embodiment, the fixture comprises:
a first component comprising a first cover that is sized and configured for covering one open end of an article; and
a second component comprising a second cover that is sized and configured for covering another open end of an article,
wherein at least one of the first component and the second component has a mechanism joined thereto for joining the first and second components together around the article in a spaced apart relationship, and one of the first component and the second component comprises at least one port for transferring heat into the interior space of an article.

A method of heating part of a turbine engine in order to service the same is also provided. The part of the turbine engine has two open ends and portions that define an interior space. The method comprises the steps of:
a. providing a fixture for use in heating part of the engine, the fixture comprising:
   i. a first component comprising a first cover that is sized and configured for covering one open end of the part of the engine; and
   ii. a second component comprising a second cover that is sized and configured for covering another open end of the part of the engine,
wherein at least one of the first component and the second component has a mechanism joined thereto for joining the first and second components together around the part of the engine in a spaced apart relationship, and one of the first component and the second component comprises at least one port for transferring heat into the interior space of the part of the engine;
b. positioning the fixture so that the first component covers one open end of the part of the engine and the second component covers another open end of the part of the engine, and joining the first and second components together around the part of the engine in a spaced apart relationship using the mechanism;
c. connecting a heat source to the at least one port for transferring heat into the interior space of the part of the engine; and
d. heating the interior space using the heat source.

Additional objects, advantages, and novel features of the invention will be set forth in part in the description which follows, and in part will become apparent to those skilled in the art upon examination of the following or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated in and constitute a part of this specification, illustrate embodiments of the present invention and, together with a general description of the invention given above, and the detailed description of the embodiments given below, serve to explain the principles of the present invention.

FIG. 1 is a perspective view showing a portion of an article, such as the #5 bearing area on the F110 model jet engine, with one embodiment of a fixture for use in heating the article in place thereon.

FIG. 2 is a perspective view of one embodiment of a fixture for use in heating the #5 bearing area on a jet engine in which the components of the fixture are assembled in their in-use configuration.

FIG. 3 is a top view of the first component of the fixture shown in FIG. 2

FIG. 4 is a side view of the first component of the fixture shown in FIG. 2.

FIG. 5 is a top view of the second component of the fixture shown in FIG. 2.

FIG. 6 is a side view of the second component of the fixture shown in FIG.

It should be understood that the appended drawings are not necessarily to scale, presenting a somewhat simplified representation of various features illustrative of the basic principles of the invention. The specific design features of the sequence of operations as disclosed herein, including, for example, specific dimensions, orientations, locations, and shapes of various illustrated components, will be determined in part by the particular intended application and used environment. Certain features of the illustrated embodiments have been enlarged or distorted relative to others to facilitate visualization and clear understanding. In particular, thin features may be thickened, for example, for clarity of illustration.

### DETAILED DESCRIPTION OF THE INVENTION

The present invention relates generally to heating articles, and more particularly to a fixture and a method for heating part of a turbine engine in order to service the same.

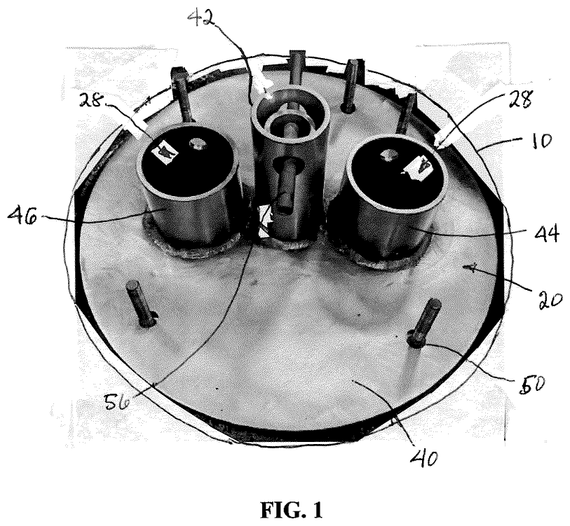

The fixture and method described herein can be used in heating any article that has two open ends and portions that define an interior space. FIG. 1 shows one example of an article 10 that has two open ends and portions that define an interior space. In FIG. 1, a portion of one end of the article 10 is shown schematically with the fixture in place therein. For simplicity, the article 10 can be thought of as being (generally) in the configuration of a cylinder. In this case, the article may be the #5 bearing area on a F110-100/129 model jet engine. The article 10 must be heated to elevated temperatures in order to install and/or remove parts from the same.

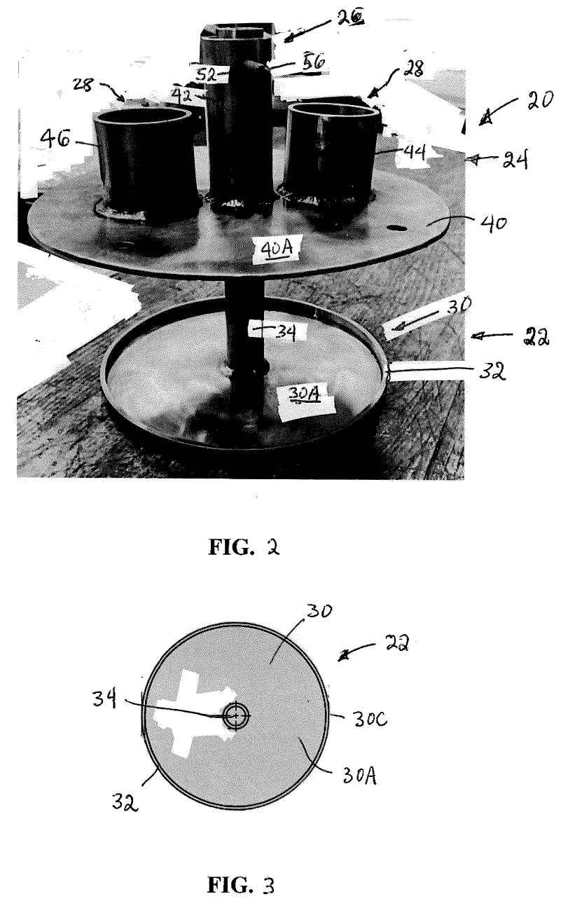

FIG. 2 shows one embodiment of a fixture 20 for use in heating the #5 bearing area on a jet engine. In FIG. 2, the components of the fixture 20 are assembled in their in-use configuration. The components of the fixture 20 generally comprise a first component 22, a second component 24, and mechanism 26 for joining the first and second components together around the article 10 in a spaced apart relationship. At least one of the first component 24 and the second component 26 comprises at least one port 28 for transferring heat into the interior space of the article.

FIGS. 2-4 show that the first component 22 comprises a first cover that is sized and configured for covering one open end of the article. The first cover can be any shape suitable for covering one open end of the article. More specifically, in this embodiment, the first component 22 comprises a first cover in the form of a first circular plate 30 having a first surface 30A, a second surface 30B, a periphery 30C, and a peripheral lip 32 extending perpendicularly outward from the first surface 30A of the first circular plate.

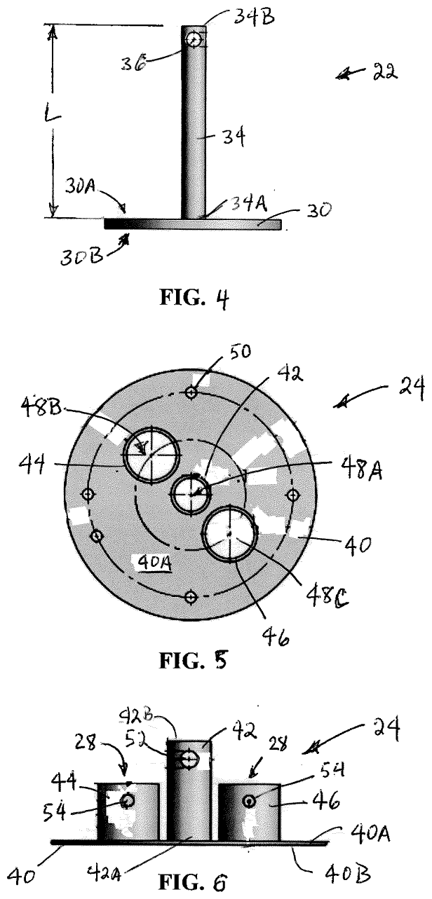

In this embodiment, an elongated member 34 is joined to the first surface 30A of the first circular plate 30 and extends perpendicularly from the center of the first circular plate 30. The elongated member 34 may be referred to as the elongated central member. The term “perpendicular” may be replaced with the term “substantially perpendicular” throughout this description. The term “substantially perpendicular”, as used herein, means within about 5 degrees of being perpendicular. FIG. 4 shows that the elongated member 34 has a length L extending between a proximal end 34A where it is joined to the first circular plate 30, a distal end 34B, and a width. The elongated member 34 can have any configuration that is suitable for fitting inside the sleeve 42 of the second component 24. The elongated member 34 can, for example, be in the form of a solid rod or a cylindrical tube. The elongated member 34 can have any suitable cross-sectional shape including, but not limited to circular.

The elongated member 34 forms at least part of the mechanism 26 for joining the first and second components 22 and 24 together around the article 10 in a spaced apart relationship. In this embodiment, the elongated member 34 has a pin-receiving hole 36 therethrough that adjacent to the distal end 34B, which hole 36 is perpendicular to the length of the member 34. The length of the elongated member 34 should be such that the distance between the proximal end 34A of the elongated member 34 and the pin-receiving hole 36 should be sufficient to enclose the ends of the article 10 to be heated when a pin is placed through the pin-receiving hole 36 and the fixture 20 is in use.

FIGS. 2 and 5-6 show that the second component 24 comprises a second cover that is sized and configured for covering another open end of the article 10. The second cover can be any shape suitable for covering the other open end of the article. In this embodiment, second component 24 comprises a second circular plate 40 having a first surface 40A and a second surface 40B. This embodiment of the second component 24 comprises three tubular members 42, 44, and 46 that are joined to the first surface 40A of the second circular plate 40. There are three through-holes 48A, 48B, and 48C in the second circular plate. One of the through holes is a central through hole 48A. The second circular plate 40 may have a second set (or plurality) of through holes 50 therein for bolts to pass through to further secure the second circular plate 40 to the article 10.

In the embodiment shown, the three tubular members 42, 44, and 46 may be cylindrical, in which case they may be referred to as “cylindrical members”. In other embodiments, however, the tubular members 42, 44, and 46 may have any suitable cross-sectional shape, provided that one of the tubular members is configured as a sleeve for accepting the elongated member 34, and the other tubular members are configured for accepting heaters for transferring heat into the interior space of the article 10. The three tubular members 42, 44, and 46 are joined to the first surface 40A of the second circular plate 40 so that one of the tubular members 42, 44, and 46 surrounds one of the through holes 48A, 48B, and 48C (e.g., tubular member 42 surrounds through hole 48A, tubular member 44 surrounds through hole 48B, and tubular member 46 surrounds through hole 48C). The tubular members 42, 44, and 46 may extend substantially perpendicular to the first surface 40A of the second circular plate 40.

The tubular members include a central cylindrical member (or “sleeve”) 42 that is joined to a center portion of the second circular plate 40. The cylindrical member 42 surrounds through hole 48A. Cylindrical member 42 has an inside dimension (e.g., a width or inside diameter) that is greater than the width of the elongated member 34 of the first component 22. The central cylindrical member 42 has a length, a proximal end 42A, and a distal end 42B. The central cylindrical member 42 is joined around the central through hole 48A at central location on the first surface 40A of the second circular plate 40. The central cylindrical member 42 is sized and configured for receiving the distal end 34B of the elongated member 34 therein. The central cylindrical member 42 has an outer pin-receiving hole 52 therethrough that is perpendicular to the length of the central cylindrical member 42 adjacent to its distal end 42B.

The fixture 20 comprises at least one port 28 for transferring heat into the interior space of the article. The port(s) 28 can be provided in the first component 22, the second component 24, or both. In the embodiment shown in the drawings, the port(s) 28 are provided in the second component 24. There can be a single port, or any suitable number (that is, a plurality) of ports 28. In the embodiment shown in the drawings, the through holes 48B and 48C comprise the ports 28. The cylindrical members include a pair of side cylindrical members 44 and 46 that are positioned to the side of central cylindrical member 42 and surround through holes 48B and 48C, respectively. The side cylindrical members 44 and 46 are sized and configured for receiving and holding heaters for transferring heat into the interior space of the article 10. The side cylindrical members 44 and 46 may have holes 54 in one side wall of their cylinder for joining a non-self-locking nut thereto for use with a bolt that can hold a portion of the heaters inside the side cylindrical members 44 and 46.

The mechanism 26 for joining the first and second components 22 and 24 may comprise any suitable mechanism for holding the first and second components together around the article 10 in a spaced apart relationship. In the embodiment shown in the drawings, as shown in FIG. 2, this mechanism is formed by insertion of the elongated member 34 into the central cylindrical member 42, and the insertion of a pin 56, such as a releasable pin (quick-release pin), through the pin receiving holes 36 and 52, respectively, in the same.

Numerous other embodiments are possible. For example, in an alternative embodiment, the mechanism 26 for joining the first 22 and second components 24 may comprise another type of fastener on the end of the elongated central member 34. For instance, the end of the elongated member 34 can be threaded and configured for a wing nut to be fastened to the same.

The heating fixture 20 can be made in any suitable manner, and from any suitable materials. The heating fixture 20 can be made by machining the components and/or by welding pieces of metal together to form the components. Suitable materials include, but are not limited to stainless steel.

The heating fixture 20 can be used in any suitable manner. In one case, the heating fixture 20 attaches onto the #5 sump housing of the #5 bearing area on an F110-100/129 model jet engine. In this case, the first cover 30 of the first component 22 of the fixture 20 is attached to the aft portion of the #5 sump housing and the second cover 40 of the second component 24 of the fixture 20 attached to the forward portion of the #5 sump housing. The elongated member 34 that is joined to the first component 22 is inserted into the central cylindrical member 42 of the second component 24. A pin 56, such as a releasable pin (quick-release pin), is inserted through the respective aligned pin receiving holes 36 and 52 at the distal ends of the elongated member 34 and the central cylindrical member 42. Heat guns (Master Appliance model HG-751B-20 or equivalent) are inserted into the ports 28 of the heating fixture 20 to heat the bearing area up to 250-300 degrees Fahrenheit. After the bearing area is heated to the desired temperature, the quick-release pin can be removed and the first and second components 22 and 24 can be separated and removed from the sump housing.

The term “joined”, as used herein, encompasses configurations in which an element is directly secured to another element by affixing the element directly to the other element; configurations in which the element is indirectly secured to the other element by affixing the element to intermediate member(s) which in turn are affixed to the other element; and configurations in which one element is integral with another element, i.e., one element is essentially part of the other element. The term “joined” includes both those configurations in which an element is temporarily joined to another element, or in which an element is permanently joined to another element.

While the present invention has been illustrated by a description of one or more embodiments thereof and while these embodiments have been described in considerable detail, they are not intended to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the scope of the general inventive concept.

1. A fixture for use in heating an article that has two open ends and portions that define an interior space, said fixture comprising:
a. a first component comprising a first cover that is sized and configured for covering one open end of an article; and
b. a second component comprising a second cover that is sized and configured for covering another open end of an article,
wherein at least one of said first component and said second component has a mechanism joined thereto for joining said first and second components together around the article in a spaced apart relationship, and one of said first component and said second component comprises at least one port for transferring heat into the interior space of an article.

2. A bearing area heating fixture for use in heating part of a jet engine comprising:
a. a first component comprising a first circular plate having a first surface, a second surface, a center, and a periphery; and
b. an elongated member that is joined to the first surface of the first circular plate and that extends perpendicularly from the center of the first circular plate, said elongated member having a length extending between a proximal end where it is joined to the first circular plate and a distal end, and a width, wherein said elongated member has a pin-receiving hole therethrough that is perpendicular to the length of the elongated member adjacent to its distal end; and
c. a second component comprising a second circular plate having a first surface, a second surface, and a center, and three through holes in the second circular plate, wherein three tubular members are joined to the first surface of said second circular plate so that a single tubular member surrounds a single through hole and said tubular members extend substantially perpendicular to the first surface of the second circular plate, said three tubular members comprising:
i. a central tubular member having a width that is greater than the width of the elongated member, said central tubular member having a length, a proximal end, and a distal end, wherein one of the through holes is a central through hole, and said central tubular member is joined around the central through hole at central location on the first surface of said second circular plate, and said central tubular member is sized and configured for receiving the distal end of the elongated member therein, wherein said central tubular member has an outer pin-receiving hole therethrough that is perpendicular to the length of the central tubular member adjacent to its distal end; and
ii. a pair of outer tubular members comprising ports that are sized and configured for receiving and holding heaters for transferring heat into the interior space of the article,
wherein the elongated member is configured to be inserted from the second surface of the second component into the central tubular member of the second component and held in place therein.

3. A method of heating part of a turbine engine in order to service the same, which part has two open ends and portions that define an interior space, said method comprising the steps of:
a. providing a fixture for use in heating part of the engine, said fixture comprising:
i. a first component comprising a first cover that is sized and configured for covering one open end of the part of the engine; and
ii. a second component comprising a second cover that is sized and configured for covering another open end of the part of the engine,
wherein at least one of said first component and said second component has a mechanism joined thereto for joining said first and second components together around the part of the engine in a spaced apart relationship, and one of said first component and said second component comprises at least one port for transferring heat into the interior space of the part of the engine;
b. positioning the fixture so that the first component covers one open end of the part of the engine and the second component covers another open end of the part of the engine, and joining said first and second components together around the part of the engine in a spaced apart relationship using said mechanism;
c. connecting a heat source to said at least one port for transferring heat into the interior space of the part of the engine; and
d. heating the interior space using the heat source.

4. The method of claim 3 wherein the turbine engine is an F110-100/129 model engine, and the part of the turbine engine is the #5 bearing area of the engine, wherein the step d of heating the interior space comprises heating the bearing area up to 250-300 degrees Fahrenheit.
